(19) United States
(12) Patent Application Publication
(10) Pub. No.: US 2019/0246281 A1
(43) Pub. Date: Aug. 8, 2019

(54) NETWORK DEVICE DATA EXCHANGE COORDINATION

(71) Applicant: ATC Technologies, LLC, Reston, VA (US)

(72) Inventors: Ilya Ziskind, Sterling, VA (US); David Nance, Sterling, VA (US)

(21) Appl. No.: 16/263,994

(22) Filed: Jan. 31, 2019

Related U.S. Application Data
(60) Provisional application No. 62/625,422, filed on Feb. 2, 2018.

(51) Int. Cl. H04W 12/08; H04W 72/04; H04L 29/06

(52) U.S. Cl. CPC H04W 12/0808; H04W 72/0453; G06N 20/00; H04L 63/0227; H04L 63/12; H04L 63/0209

(57) ABSTRACT

Devices and methods for exchanging data over a network are described. One device includes a communication interface and an electronic processor coupled to the communication interface. The electronic processor is configured to receive, via the communication interface, at least one network message including a payload associated with an IoT device. The electronic processor is configured to retrieve a data exchange policy for the IoT device. The electronic processor is configured to determine whether the payload is valid based on the data exchange policy. The electronic processor is configured to in response to determining that the payload is invalid, process the at least one network message based on the data exchange policy.

### RELATED APPLICATION

The present application claims the benefit of co-pending U.S. Provisional Patent Application No. 62/625,422, filed Feb. 2, 2018, the entire contents of which are hereby incorporated by reference.

### FIELD

Embodiments described herein relate to computer networks and, more particularly, to Internet of Things (IoT) traffic inspection and data validation.

### SUMMARY

The Internet of Things uses the Internet and other networks to connect devices and other items embedded with combinations of electronics, software, sensors, actuators, and network connectivity (known as “connected devices,” “smart devices,” or “IoT Devices”). This connection enables these objects to collect and exchange data (for example, to issue commands to remotely control equipment or processes). IoT devices may be used to monitor (for example, using sensors) and control industrial processes (for example, manufacturing), infrastructure processes (for example, water treatment and distribution), facility processes (for example, interior climate control and other building management processes), and other automatable processes. IoT devices are also used in the healthcare field to remotely monitor patients and administer treatments.

IoT devices are typically connected to remote control systems via the Internet and other open or semi-secure networks. As a consequence, such devices may be susceptible to malicious interference, hacking, computer worms, or viruses, deliberate attempts to overload a system, broadcast attacks, or other internet attacks. Current solutions use firewalls and other network security measures to attempt to address this concern, but the current solutions are data-agnostic and based solely on ensuring that network traffic to and from the IoT device is properly addressed and formatted (that is, according to the correct protocol). Thus, IoT devices may still be compromised by the underlying data, for example, using a “man-in-the-middle” attack. For example, commands to turn systems on or off at the wrong time will still be allowed, so long as the network messages carrying those commands are properly addressed and use the correct protocol. Thus, embodiments described herein provide, among other things, systems, devices, and methods for network device data exchange coordination.

For example, in one aspect, a method is provided for coordinating data exchange with an IoT device. The method includes receiving, via a communication interface, at least one network message including a payload associated with the IoT device. The method includes retrieving a data exchange policy for the IoT device. The method includes determining whether the payload is valid based on the data exchange policy. The method includes, in response to determining that the payload is invalid, dropping the at least one network message.

In another aspect, an electronic device is provided and includes a communication interface and an electronic processor coupled to the communication interface. The electronic processor is configured to receive, via the communication interface, at least one network message including a payload associated with the IoT device. The electronic processor is configured to retrieve a data exchange policy for the IoT device. The electronic processor is configured to determine whether the payload is valid based on the data exchange policy. The electronic processor is configured to, in response to determining that the payload is invalid, process the at least one network message based on the data exchange policy.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a system for IoT traffic inspection and data validation according to some embodiments.

FIG. 2 is a diagram of the IoT Firewall of FIG. 1 according to some embodiments.

FIG. 3 is a flow chart of a method for coordinating data exchange with an IoT device according to some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

It should also be noted that a plurality of hardware and software based devices, as well as a plurality of different structural components may be used to implement the invention. In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronics based aspects of the invention may be implemented in software (for example, stored on non-transitory computer-readable medium) executable by one or more processors. As such, it should be noted that a plurality of hardware and software based devices, as well as a plurality of different structural components may be utilized to implement the invention. For example, “control units” and “controllers” described in the specification can include one or more processors, one or more memory modules including non-transitory computer-readable medium, one or more input/output interfaces, and various connections (for example, a system bus) connecting the components.

For ease of description, each of the exemplary systems or devices presented herein is illustrated with a single exemplar of each of its component parts. Some examples may not describe or illustrate all components of the systems. Other exemplary embodiments may include more or fewer of each of the illustrated components, may combine some components, or may include additional or alternative components.

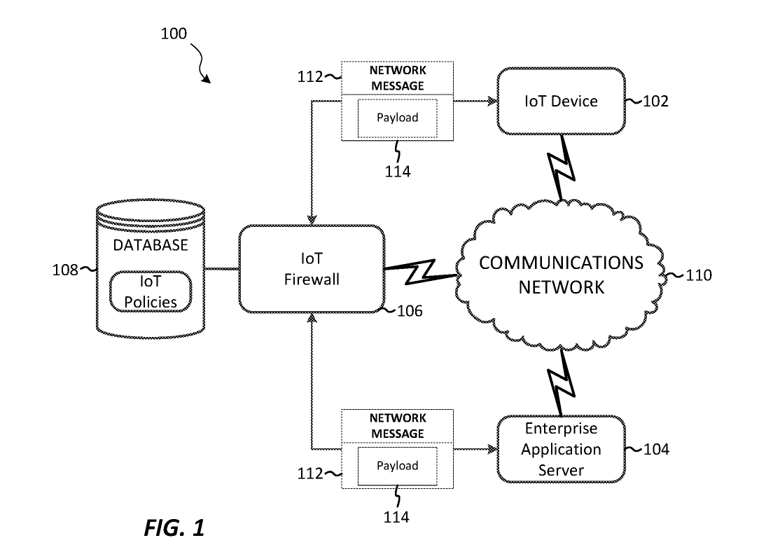

FIG. 1 is a diagram of an example system 100 for coordinating data exchange with an IoT device 102. The system 100 includes an enterprise application server 104, an IoT firewall 106, and a database 108. It should be understood that the system 100 is provided as an example and, in some embodiments, the system 100 includes additional components. For example, the system 100 may include multiple enterprise application servers 104, multiple IoT firewalls 106, multiple databases 108, or a combination thereof. In particular, it should be understood that although FIG. 1 illustrates a single IoT device 102, the system 100 may coordinate data exchange for tens, hundreds, or thousands of IoT devices.

The enterprise application server 104, the IoT device 102, and the IoT firewall 106 are communicatively coupled via a communications network 110. The communications network 110 may be a wired or wireless network or networks, operating according to suitable internet protocols (for example, Transmission Control Protocol (TCP), Internet Protocol (IP), and User Datagram Protocol (UDP)). The terms “internet protocol” and “internet protocols,” as used herein, may refer to Internet Protocol version 4 (IPv4), Internet Protocol version 6 (IPv6), future-developed internet protocols, or some combination of the foregoing. All or parts of the communications network 110 may be implemented using one or more existing networks, for example, a cellular network, the Internet, a land mobile radio (LMR) network, a short-range (for example, Bluetooth™) wireless network, a wired or wireless wide area network (WAN), a wireless local area network (for example, Wi-Fi), and a public switched telephone network (PSTN). The communications network 110 may also include future-developed networks. In some embodiments, communications with other external devices (not shown) occurs over the communications network 110.

The enterprise application server 104 is a computer server or other computing device (including, for example, a processor, memory, and communications interface). The enterprise application server 104 includes hardware and software that enables a user of the enterprise application server 104 to send and receive commands, queries, and other data to and from at least the IoT device 102. As described in detail below, the enterprise application server 104 sends and receives network messages 112 to and from IoT device 102. Each network message 112 contains a payload 114. The payload 114 can include commands, queries, and/or other data. For example, the payload 114 may be a command to the IoT device, a configuration setting for the IoT device, an operational state for the IoT device, a data query to the IoT device, a data value from the IoT device, or another parameter associated with the IoT device, or various combinations of one or more of the foregoing. In some embodiments, the network messages 112 are made up of one or more TCP or UDP packets.

The IoT device 102 is an electronic device that includes electronics, software, sensors, actuators, and network connectivity. The IoT device 102 may be coupled to or integrated with another electrical, electronic, or electromechanical device to monitor or control such device. For example, the IoT device 102 may be used to monitor water pressure at various points in a water distribution system, and to control a pump to fill a water tower when water pressure readings fall below a threshold level. Some IoT devices 102 are standalone, for example, remote sensors that monitor conditions (for example, temperature, pressure, humidity, water levels, equipment status, and the like). As used herein, the term “IoT device” may refer to a more complex system with IoT connectivity, for example, a “smart refrigerator,” or it may refer to only the device or components that provide the IoT connectivity to a larger device or system. Some IoT devices 102 are configured to control or monitor multiple devices.

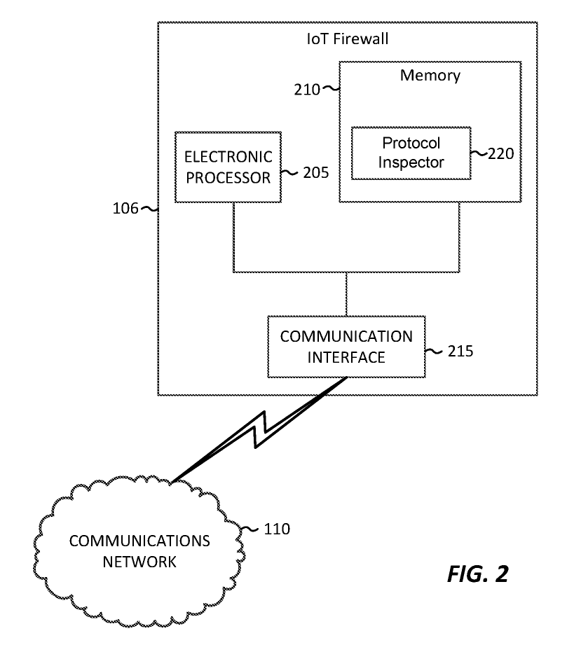

The IoT firewall 106, described more particularly below with respect to FIG. 2, is communicatively coupled to, and writes data to and from, the database 108. As illustrated in FIG. 1, the database 108 may be a database housed on a suitable database server communicatively coupled to and accessible by the IoT firewall 106. In alternative embodiments, the database 108 may be part of a cloud-based database system external to the system 100 and accessible by the IoT firewall 106 over one or more additional networks. In some embodiments, all or part of the database 108 may be locally stored on the IoT firewall 106. In some embodiments, as described below, the database 108 electronically stores data on IoT devices and IoT device policies.

In some embodiments, the IoT firewall 106 performs machine learning functions (for example, to develop the IoT device policies). Machine learning generally refers to the ability of a computer program to learn without being explicitly programmed. In some embodiments, a computer program (for example, a learning engine) is configured to construct an algorithm based on inputs. Supervised learning involves presenting a computer program with example inputs and their desired outputs. The computer program is configured to learn a general rule that maps the inputs to the outputs from the training data it receives. Example machine learning engines include decision tree learning, association rule learning, artificial neural networks, classifiers, inductive logic programming, support vector machines, clustering, Bayesian networks, reinforcement learning, representation learning, similarity and metric learning, sparse dictionary learning, and genetic algorithms. Using one or more of these approaches, a computer program can ingest, parse, and understand data and progressively refine algorithms for data analytics.

FIG. 2 illustrates an example of the IoT firewall 106. In the embodiment illustrated, the IoT firewall 106 includes an electronic processor 205, a memory 210, and a communication interface 215. The illustrated components, along with other various modules and components are coupled to each other by or through one or more control or data buses that enable communication therebetween.

The electronic processor 205 obtains and provides information (for example, from the memory 210 and/or the communication interface 215), and processes the information by executing one or more software instructions or modules, capable of being stored, for example, in a random access memory (“RAM”) area of the memory 210 or a read only memory (“ROM”) of the memory 210 or another non-transitory computer readable medium (not shown). The software can include firmware, one or more applications, program data, filters, rules, one or more program modules, and other executable instructions. The electronic processor 205 is configured to retrieve from the memory 210 and execute, among other things, software related to the control processes and methods described herein.

The memory 210 can include one or more non-transitory computer-readable media, and includes a program storage area and a data storage area. As used in the present application, “non-transitory computer-readable media” comprises all computer-readable media but does not consist of a transitory, propagating signal. The program storage area and the data storage area can include combinations of different types of memory, as described herein. In the embodiment illustrated, the memory 210 stores, among other things, a software-based protocol inspector 220. In some embodiments, the software-based protocol inspector 220 decodes and analyzes network messages 112, as described below.

The communication interface 215 may include one or more wireless transmitters or transceivers for wirelessly communicating over the communications network 110. Alternatively or in addition to wireless transmitters or transceivers, the communication interface 215 may include one or more ports for receiving cable, such as Ethernet cables, for communicating over the communications network 110 or dedicated wired connections. It should be understood that, in some embodiments, the IoT firewall 106 communicates with the enterprise application server 104, the IoT device 102, or both through one or more intermediary devices, such as routers, gateways, relays, and the like.

In some embodiments, the enterprise application server 104 (FIG. 1) communicates with the IoT device 102 via the IoT firewall 106, such that no network messages 112 are transferred between the enterprise application server 104 and the IoT device 102 without first passing through and being processed by the IoT firewall 106.

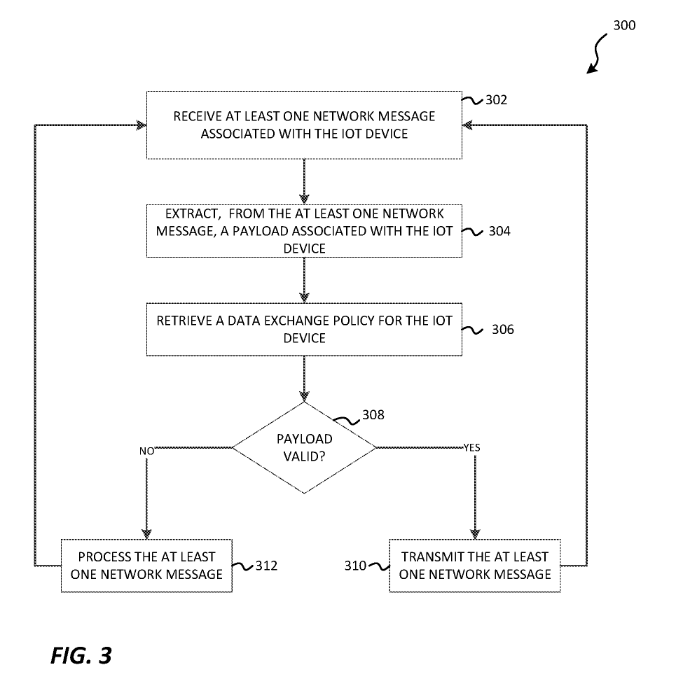

As noted above, current network security methods focus only on sending (for example, where network messages are going), receiving (for example, where network messages are coming from), and network protocols. Such methods are thus inadequate to protect the IoT device 102 from malicious interference using the data payload. Accordingly, methods are provided herein to perform deep packet inspection at the application level to protect the IoT device. For example, FIG. 3 illustrates an example method 300 for IoT traffic inspection and data validation. The method 300 is described as being performed by the IoT firewall 106 and, in particular, the electronic processor 205. However, it should be understood that in some embodiments, portions of the method 300 may be performed external to the IoT firewall 106 by other computing devices.

As an example, the method 300 is described in terms of a single enterprise application server 104 communicating with a single IoT device 102 via a single IoT firewall 106. However, it should be understood that embodiments of the method 300 may be implemented across multiple IoT firewalls 106 and for use with multiple IoT devices 102 and IoT firewalls 106. At block 302, the electronic processor 205 receives (for example, via the communication interface 215) one or more network messages 112 associated with the IoT device 102. The one or more network messages 112 are associated with the IoT device 102 when they are sent from or addressed to the IoT device 102. For example, the enterprise application server 104 may send (user-initiated or automatically) a command to the IoT device 102 to perform a function. For example, the enterprise application server 104 may be part of an automated healthcare system issuing a command to an insulin pump to administer a dose to a patient. In another example, the IoT device 102 may be reporting data to the enterprise application server 104. For example, the IoT device 102 may be a temperature sensor reporting the temperature of a building to the enterprise application server 104.

As noted above, each network message 112 includes a payload 114. Accordingly, at block 304, the electronic processor 205 extracts, from the at least one network message, a payload associated with the IoT device 102. In some embodiments, the payload 114 is extracted using deep packet inspection (for example, as performed by the software-based protocol inspector 220) of the application layer of the network message 112.

The payload is associated with the IoT device 102. For example, the payload may be a command to the IoT device 102, a configuration setting for the IoT device 102, an operational state for the IoT device 102, a data query to the IoT device 102, or a data value from the IoT device 102. As noted above, attempts may be made with malicious intent to alter the payload to cause discomfort or harm. For example, attempts may be made to disrupt utilities, to injure persons, to damage property, or to otherwise cause harm by sending incorrect data in the payload 114. For example, a command may be issued to an insulin pump or other medical device to administer a dose, which is harmful rather than helpful. In other instances, data corruption or other malfunction at the enterprise application server 104 may cause errant, conflicting, or otherwise potentially damaging payloads to be transmitted.

To ensure that the payload 114 is valid, in some embodiments, the IoT firewall 106 compares the payload 114 to a data exchange policy for the IoT device 102. The data exchange policy is an information model of the capabilities of the IoT device 102. The data exchange policy is based on the IoT device 102, and includes indications of what types of data are acceptable for the IoT device 102, what ranges of data are acceptable for the IoT device 102, as well as other rules that may be used to qualify the payload. For example, the data exchange policy may indicate that a valve controller should only accept commands related to valve control. In another example, a data exchange policy may indicate that an insulin pump should only accept dosage commands of an acceptable range of values and activate no more than once per hour. In another example, a data exchange policy may indicate that a temperature sensor is only allowed to submit temperature values falling within a specified range and at specified times. In another example, a data exchange policy may indicate that a controller will not accept data queries of a certain type or types, or at all. A data exchange policy may be unique to a particular IoT device 102, or it may be applicable to a group of devices, for example, based on the device type.

In some embodiments, the IoT firewall 106 may construct or update the data exchange policy automatically using machine learning, for example, based on what payload types and values are manually approved or denied by users over time. For example, the IoT device 102 may be a combination sensor/actuator for a residential indoor HVAC unit. In such case, the data reported may not need to be particularly precise, and a workable schema would store this data as a series of integers over time, with a lower bound of −50° F. and an upper bound of 150° F. The schema may include additional trigger conditions, for example, a preferred temperature of 45° F.+/−2° F. (for example, it may be occupied only on weekends and need only be kept from freezing otherwise). As the area is occupied, for example, on Friday evening, it is desirable to change the temperature to a more hospitable 70° F. In some embodiments, given an IoT device of this type, such a schema is auto-built based on the IoT device type (so that it is not necessary to identify that it is desirable to store time-series data of type integer within reasonable bounds). In such embodiments, the policy constructed from this (to guide the operation of the firewall) would be pre-filled. As the IoT firewall 106 operates over time, it would use machine learning to adjust the policy such that attempts to set the temperature to an unreasonable value would generate an exception case. Furthermore, over time, the IoT firewall 106 would learn approximately when a user adjusts the temperature value, so change requests outside that time window might generate an exception case.

At block 306, the electronic processor 205 retrieves a data exchange policy for the IoT device. In some embodiments, the data exchange policy is retrieved from the database 108. In some embodiments, the data exchange policy is retrieved based on the network address for the IoT device 102. In other embodiments, the data exchange policy is retrieved based on a device type for the IoT device 102.

At block 308, the electronic processor 205 determines whether the payload is valid based on the data exchange policy (retrieved at block 306). In some embodiments, the data exchange policy may include an acceptable range for the payload. For example, as noted above, an acceptable range for an insulin pump may be a dosage range. In such embodiments, the payload (for example, a dosage request) is compared to the acceptable range (for example, the allowable dosage range). In other embodiments, the data exchange policy may include an acceptable transmission frequency range for the payload. For example, it may only be acceptable to transmit an insulin dosage command once per hour. In such embodiments, the transmission frequency of the payload type (e.g., a dosage command) is compared to the acceptable transmission frequency range (e.g., the number of dosage commands allowed per unit of time). When a payload value falls within the acceptable range, it is considered a valid payload. Likewise, when the frequency of the payload type falls within the acceptable frequency range, it is considered a valid payload. Payloads falling outside the ranges are considered invalid. A payload is determined to be invalid regardless of whether the network message containing it is formed or addressed correctly.

At block 310, in response to determining that the payload is valid, the electronic processor 205 transmits the at least one network message (for example, via the communications interface 215) to its destination (for example, the IoT device 102 or the enterprise application server 104).

At block 312, in response to determining that the payload is invalid, the electronic processor 205 processes the at least one network message. For example, the electronic processor 205 may drop (delete without forwarding) the at least one network message. In some embodiments, the electronic processor 205 may take some other or additional actions, for example, as specified in the data exchange policy. For example, the electronic processor 205 may store the message in quarantine for further analysis or potential transmission upon being released (for example, by a user command). In another example, the electronic processor 205 may generate an alarm based on the invalid payload. For example, the IoT firewall 106 may send an email or text message to alert a user of the invalid payload.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

Various features and advantages of some embodiments are set forth in the following claims.

What is claimed is:

1. An electronic device comprising:
a communication interface; and
an electronic processor coupled to the communication interface and configured to receive, via the communication interface, at least one network message including
a payload associated with an IoT device;
retrieve a data exchange policy for the IoT device;
determine whether the payload is valid based on the data exchange policy; and
in response to determining that the payload is invalid, process the at least one network message based on the data exchange policy.

2. The electronic device of claim 1, wherein the electronic processor is further configured to in response to determining that the payload is valid, transmit, via the communication interface, the at least one network message.

3. The electronic device of claim 1, wherein the electronic processor is further configured to extract, from the at least one network message, a payload associated with the IoT device.

4. The electronic device of claim 1, wherein the electronic processor is further configured to
retrieve an acceptable range for the payload; and
determine whether the at least one network message is valid by comparing the acceptable range to the payload.

5. The electronic device of claim 1, wherein the electronic processor is further configured to
determine a transmission frequency for the payload;
retrieve an acceptable transmission frequency range for the payload; and
determine whether the at least one network message is valid by comparing the transmission frequency to the acceptable transmission frequency range.

6. The electronic device of claim 1, wherein the electronic processor is further configured to
extract the payload from an application layer of the at least one network message.

7. The electronic device of claim 1, wherein the payload includes at least one selected from a group consisting of a command to the IoT device, a configuration setting for the IoT device, an operational state for the IoT device, a data query to the IoT device, and a data value from the IoT device.

8. The electronic device of claim 1, wherein the electronic processor is further configured to process the at least one network message by dropping the at least one network message.

9. The electronic device of claim 1, wherein the electronic processor is further configured to process the at least one network message by placing the at least one network message in quarantine.

10. The electronic device of claim 1, wherein the electronic processor is further configured to process the at least one network message by generating an alarm.

11. A method for coordinating data exchange with an IoT device, the method comprising:
receiving, via a communication interface, at least one network message including a payload associated with the IoT device;
retrieving a data exchange policy for the IoT device;
determining whether the payload is valid based on the data exchange policy; and
in response to determining that the payload is invalid, processing the at least one network message based on the data exchange policy.

12. The method for coordinating data exchange with an IoT device of claim 11, further comprising:
in response to determining that the payload is valid, transmitting, via the communication interface, the at least one network message.

13. The method for coordinating data exchange with an IoT device of claim 11, further comprising:
extracting, with an electronic processor, from the at least one network message, the payload.

14. The method for coordinating data exchange with an IoT device of claim 11, wherein retrieving the data exchange policy includes retrieving an acceptable range for the payload; and
determining whether the at least one network message is valid includes comparing the acceptable range to the payload.

15. The method for coordinating data exchange with an IoT device of claim 11, further comprising:
determining a transmission frequency for the payload;
wherein retrieving the data exchange policy includes retrieving an acceptable transmission frequency range for the payload; and
wherein determining whether the at least one network message is valid includes comparing the transmission frequency to the acceptable transmission frequency range.

16. The method for coordinating data exchange with an IoT device of claim 11, wherein extracting, from the at least one network message, a payload associated with the IoT device includes extracting the payload from an application layer of the at least one network message.

17. The method for coordinating data exchange with an IoT device of claim 11, wherein extracting a payload includes extracting at least one selected from a group consisting of a command to the IoT device, a configuration setting for the IoT device, an operational state for the IoT device, a data query to the IoT device, and a data value from the IoT device.

18. The method for coordinating data exchange with an IoT device of claim 11, wherein processing the at least one network message includes dropping the at least one network message.

19. The method for coordinating data exchange with an IoT device of claim 11, wherein processing the at least one network message includes placing the at least one network message in quarantine.

20. The method for coordinating data exchange with an IoT device of claim 11, wherein processing the at least one network message includes generating an alarm.

21. A system comprising:
an IoT device;
an enterprise application server configured to remotely control the IoT device;
a database containing an information model of the capabilities of the IoT device; and
an IoT firewall, communicatively coupled to the IoT device, the enterprise application server, and the database, the IoT firewall configured to
receive, from the enterprise application server, at least one network message including a payload associated with the IoT device;
retrieve, from the database, a data exchange policy for the IoT device;
determine whether the payload is valid based on the data exchange policy; and
in response to determining that the payload is invalid, process the at least one network message based on the data exchange policy.

22. The system of claim 21, wherein the IoT firewall is further configured to
in response to determining that the payload is valid, transmit the at least one network message to the enterprise application server.

23. The system of claim 21, wherein the IoT firewall is further configured to
extract, from the at least one network message, a payload associated with the IoT device.

24. The system of claim 21, wherein the IoT firewall is further configured to
retrieve, from the database, an acceptable range for the payload; and
determine whether the at least one network message is valid by comparing the acceptable range to the payload.

25. The system of claim 21, wherein the IoT firewall is further configured to
determine a transmission frequency for the payload;
retrieve, from the database, an acceptable transmission frequency range for the payload; and
determine whether the at least one network message is valid by comparing the transmission frequency to the acceptable transmission frequency range.

26. The system of claim 21, wherein the IoT firewall is further configured to
extract the payload from an application layer of the at least one network message.

27. The system of claim 21, wherein the payload includes at least one selected from a group consisting of a command to the IoT device, a configuration setting for the IoT device, an operational state for the IoT device, a data query to the IoT device, and a data value from the IoT device.

28. The system of claim 21, wherein the IoT firewall is further configured to process the at least one network message by dropping the at least one network message.

29. The system of claim 21, wherein the IoT firewall is further configured to process the at least one network message by placing the at least one network message in quarantine.

30. The system of claim 21, wherein the IoT firewall is further configured to process the at least one network message by generating an alarm.
